(19) United States
(12) Patent Application Publication
(10) Pub. No.: US 2023/0059957 A1
(43) Pub. Date: Feb. 23, 2023

(54) LOCATOR FOR FILM STICKING ON INTELLIGENT AUTOMOBILE CENTRAL CONTROL COMPUTER SCREEN AND FILM STICKING METHOD THEREOF

(71) Applicant: Lu CHEN, Fuzhou (CN)

(72) Inventor: Lu CHEN, Fuzhou (CN)

(21) Appl. No.: 17/405,045

(22) Filed: Aug. 18, 2021

(51) Int. Cl. B32B 38/18; B32B 37/26; C09J 7/10; B60K 35/00

(52) U.S. Cl. CPC B32B 38/1833; B32B 37/26; C09J 7/10; B60K 35/00; B32B 2037/268; B32B 2605/003; B32B 2457/20; B60K 2370/68

(57) ABSTRACT

A locator for film sticking on an intelligent automobile central control computer screen and a film sticking method thereof are provided, and generally relate to the technical field of film sticking tools. The locator for film sticking on the intelligent automobile central control computer screen and the film sticking method thereof of the present disclosure comprises the film sticking mechanism, film component, and central control panel module of automobiles. The film sticking mechanism is comprised of a locator with no fewer than two L-shaped central control panel positioning stiffeners which are diagonally arranged on a side to clamp the central control panel. The protective film of the central control panel is limited by the setting of the film sticking mechanism, film component, and the cooperation of the locator with the protective positioning film, so that the protective film of the central control panel is kept in a flat state.

### TECHNICAL FIELD

The present disclosure relates to the technical field of film sticking tools, in particular, to a locator for film sticking on an intelligent automobile central control computer screen and the film sticking method thereof.

### BACKGROUND

The central control of automobiles aims to control automobile air-conditioning, audio, and other comfort-based devices. With the continuous development of automobile industry technology, new energy vehicles have gradually replaced fossil-fuel vehicles and have become a mainstream development direction. Intelligent technology is increasingly integrated into automobiles. When driving automobiles, more and more functions are available. Controlling computer communication makes for better protection of the computer screen; therefore, and a better user experience becomes particularly important.

Conventionally, due to the size of central control panels and such factors as narrow interior space, film sticking has mostly meant manual sticking. However, manual sticking features low efficiency, narrower interior space, and the film sticking process itself is prone to shaking, under which the protective film is likely to bend or tilt, which affects the film sticking result and means that it can no longer meet use demands.

### SUMMARY

In order to achieve the above objectives, this disclosure provides the following technical solutions: a locator for film sticking on a central control computer screen of an intelligent automobile and the film sticking method thereof, comprising: the film sticking mechanism, film component, and central control panel module of automobiles. The film sticking mechanism is comprised of a locator with no less than two central control panel positioning stiffeners arranged on a side of the central control panel, which are diagonally arranged to clamp the automobile central control panel module. The central control panel positioning stiffeners for the central control panel are L-shaped. A side of the locator is provided with a positioning column of protective film located inside a central control panel positioning stiffener for positioning the film component. Another side of the locator is provided with a positioning film positioning column one, and a positioning film positioning column two to a side of the positioning film positioning column one;

The film components are comprised of the protective film of the central control panel with the protective positioning film arranged on a side. A side of the protective positioning film, which is far away from the protective film of the central control screen, is pasted on the side of the locator. Both ends of the protective positioning film are provided with protrusion one. Inside protrusion one, there is the positioning film positioning column one, whose inner part is sleeved with the external side of the positioning hole one, and a positioning hole two, whose internal surface is sleeved with the external surface of the positioning film positioning column two. The top and bottom of the side of the locator are provided with more than one positioning film positioning column three. Both ends of the protective positioning film are arranged with protrusion two. The interior of protrusion two is arranged with positioning hole three, sleeved with the surface of positioning film positioning column three to limit the protective positioning film. The positioning column of the protective film is protruding and fits with the corner of the central control screen protective film to limit the central control screen protective film. An end of positioning film positioning columns one, two, and three are all provided with inverted parts far which are away from the locator.

As a preferred technical solution for this disclosure:

a side of the protective film of the central control panel which is far away from the protective positioning film is provided with a release film, and this release film, which is far away from the protective film of the central control panel, is provided with a peel-off film label.

A side of the automobile central control panel module of the automobiles is provided with a screen body, and another side is provided with central a control panel bracket. The film scraping groove is set inside of the locator.

The distance between the two protrusions is greater than the length of the protective film of the central control panel, and the distance between the two protrusions is greater than the width of the protective film of the central control panel.

An indicator sign is provided on the side of the locator away from the protective positioning film indicating the film scraping direction. Both ends of the locator are curved and the length of the locator is greater than that of the protective film of the central control panel.

The triangular supporting protrusion is set on a side of the central control panel positioning stiffener, away from the positioning column of the protective film.

The side of the locator is provided with a double-sided adhesive groove on a side of the positioning column of the protective film for pasting the 3M double-sided adhesive.

This disclosure relates to a film sticking method concerning a locator for film sticking on a central control computer screen of an intelligent automobile, wherein:

S1, while processing the film component and manufacturing the protective film of the central control panel, pasting the protective positioning film on the side, and respectively arranging the positioning hole one, the positioning hole two, and the positioning hole three on the protrusion one and the protrusion two;

S2, assembling film component, connecting the positioning hole one, the positioning hole two, and the positioning hole three on the protrusion one and the protrusion two with the positioning film positioning column one, the positioning film positioning column two, and the positioning film positioning column three, respectively, and limiting corners of the protective film of the central control panel through the positioning column of protective film to keep the protective film of the central control panel in a flat state; and

S3, upon film sticking, after peeling off the release film, aligning the central control panel positioning stiffener on the automobile central control panel and directly covering the automobile central control panel to clamp the central control panel positioning stiffener with a corner of the automobile central control panel module, lightly swiping in the middle of the film scraping groove one and then the protective film of the central control panel self-exhausting and fitting, breaking off the locator, and separating the protective positioning film from the protective film of the central control panel.

As a preferred technical solution of this disclosure, after the protective film of the central control panel in the S3 and screen body are self-exhausted and fit, it takes at least 10 seconds before the locator can be broken off, and the released film is then torn and pasted back onto protective positioning film to keep out dust.

Compared with existing technologies, this disclosure provides a locator for film sticking on a central control computer screen of an intelligent automobile and the film sticking method thereof, with the following beneficial effects:

for a locator for film sticking on a central control computer screen of an intelligent automobile and its film sticking method, the protective film of the central control panel is limited by the setting of film sticking mechanism and film component and the cooperation of the locator with the protective positioning film. The protective film of the central control panel is kept in a flat state, which is conducive to the subsequent filming work. The operation is convenient and fast, the positioning is accurate, the structure is simple and the thickness is small. Consequently, manufacturing materials are saved, processing cost is reduced, economic benefit is conferred, and the application prospect is broad. The released film can be affixed back onto the protective positioning film after being torn off, so as to prevent dust and facilitate next use.

### BRIEF DESCRIPTION OF DRAWINGS

FIG. 1 is a structural diagram of the locator;

FIG. 2 is a structural explosive diagram of the locator;

FIG. 3 is a structural diagram of the automobile central control panel module;

FIG. 4 is a structural diagram of the central control panel positioning stiffeners;

FIG. 5 is a use flow diagram of the locator;

FIG. 6 is a structural diagram of positioning film positioning column three of the locator;

FIG. 7 is a structural diagram of the positioning film positioning column two of the locator.

### DETAILED DESCRIPTION OF THE EMBODIMENTS

Clear and complete descriptions of the technical solutions in the embodiment of this disclosure will be provided in combination with the related figures in the following section. Obviously, the described embodiment is only a part of this disclosure, rather than all of it. Based on the embodiment of the present disclosure, all other embodiments acquired by ordinary technicians in this field without creative endeavors shall be within the protection scope of the present disclosure.

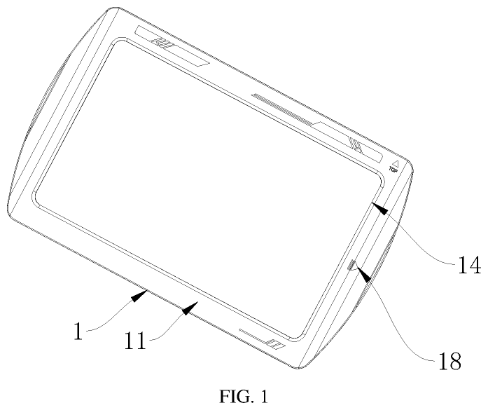

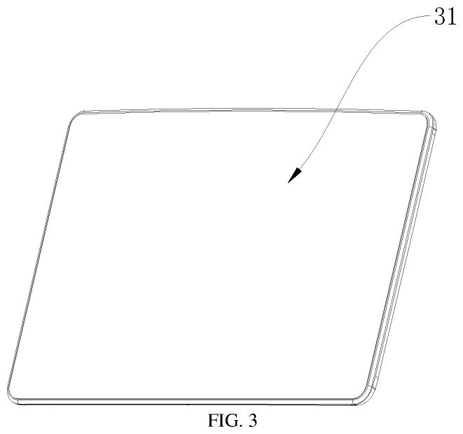

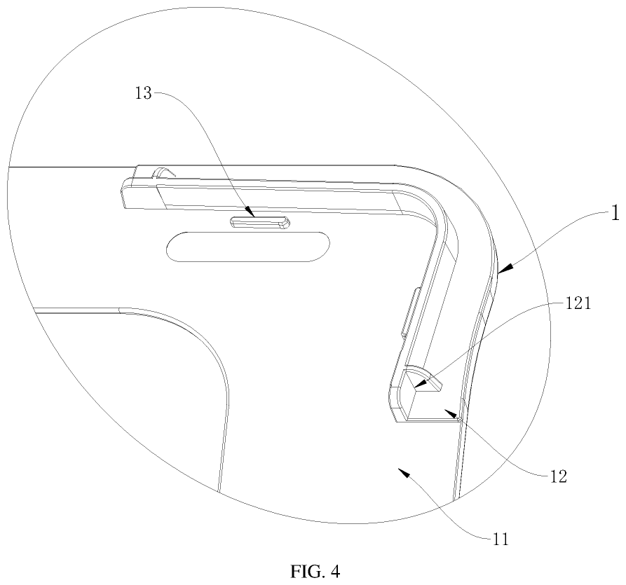

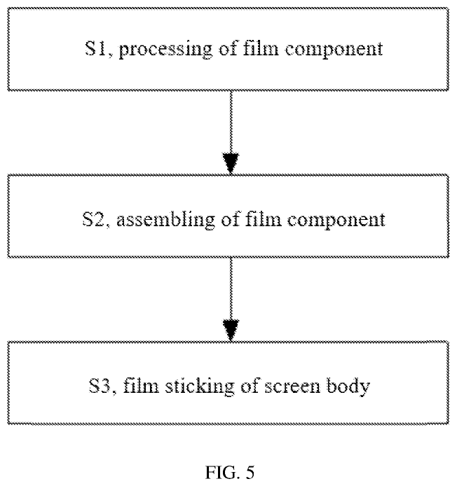

Please refer to FIG. 1-FIG. 7, a locator for film sticking on the central control computer screen of an intelligent automobile and the film sticking method thereof, comprising: the film sticking mechanism (1), film component (2), and central control panel module of automobiles (3). The film sticking mechanism (1) includes the locator (11) on a side with at least two central control panel positioning stiffeners for the central control panel (12), and the two central control panel positioning stiffeners (12) are diagonally arranged to clamp the automobile central control panel module (3). The central control panel positioning stiffeners (12) are L-shaped. A side of the locator (11) is provided with the positioning column of the protective film (13), which is located inside the central control panel positioning stiffener (12) for positioning the film component (2). The side of the locator (11) is provided with the positioning film positioning column one (15) and the positioning film positioning column two (16), located on a side of the positioning film positioning column one (15).

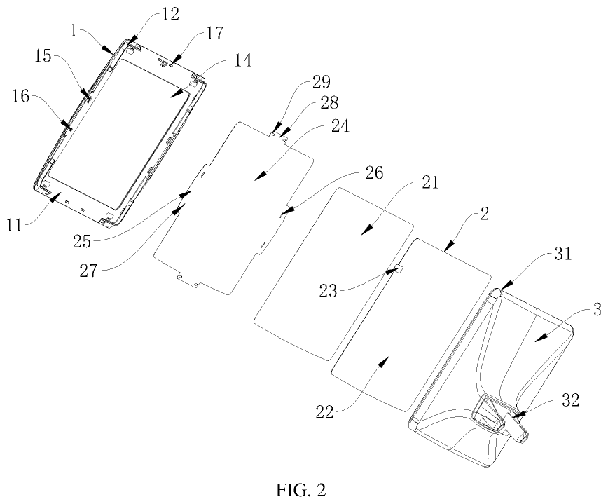

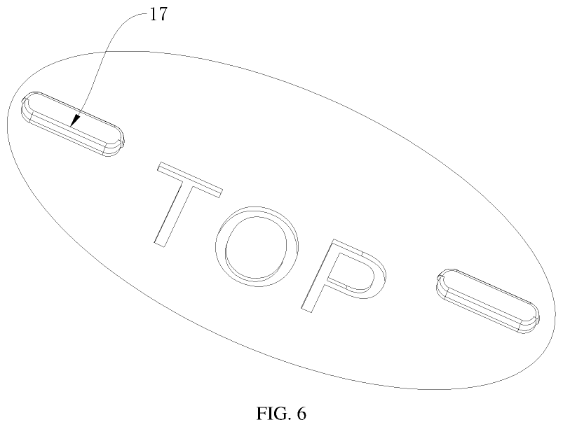

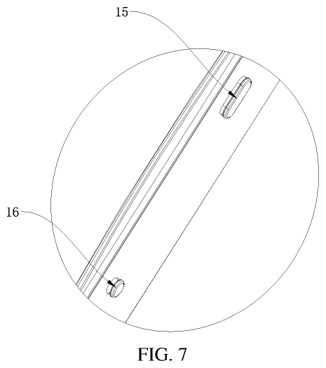

The film component (2) includes the protective film of the central control panel (21) and is provided with protective positioning film (24) on the side. The side of the protective positioning film (24) away from the protective film of the central control panel (21) is attached to the side of the locator (11), and both ends of the protective positioning film (24) are provided with protrusion one (25). The inside of protrusion one (25) is provided with positioning hole one (26), which is internally connected to the surface of the positioning film positioning column one (15) and positioning hole two (27), which is internally connected to the surface of the positioning film positioning column two (16). The top and bottom of the side of the locator (11) are both provided with not less than one positioning film positioning column three (17), and the top and bottom ends of the protective positioning film (24) are both provided with protrusion two (28). The inside of protrusion two (28) is provided with positioning hole three (29), which is sleeved on the surface of positioning film positioning column three (17) to limit the position of the protective positioning film (24) so that the positioning film (24) will not naturally detach, so the protective positioning film (24) can be limited. The protective film positioning column (13) protrudes and fits the corners of the protective film of the central control panel (21) to realize the control of the central control panel (21). By setting film sticking mechanism (1) and film component (2), the locator (11) cooperates with the protective positioning film (24) to limit the protective film of the central control panel (21) and the central control, which is kept in a flat state. The operation is convenient and fast, the positioning is accurate, the structure is simple and the thickness is small. Consequently, manufacturing materials are saved, processing cost is reduced, economic benefits are conferred, and the application prospect is broad. The released film (22) can be affixed back onto the protective positioning film (24) after being torn off, so as to prevent dust and facilitate next use. Refer to FIG. 1, FIG. 2, and FIG. 6. Both sides of the locator (11) are straight-edge shapes, which can be processed into curved and other shapes later. Refer to FIG. 6 and FIG. 7. An end of the positioning film positioning column one (15), the positioning film positioning column two (16), and positioning film positioning column three (17) are all provided with an inverted part at one end, away from the locator (11), so that positioning holes one (26), two (27), and three (28) are respectively clamped with positioning film positioning columns one (15), two (16), and three (17) to be more stable, which further ensures the stability of the protective positioning film (24), and further ensures that it will not easily detach from the locator (11) upon film tearing.

As a specific technical solution of this disclosure, the side of the protective film of the central control panel (21) placed away from the protective positioning film (24) is provided with a release film (22), and this film is located away from the protective film of the central control panel (21), which is provided with a tear-off film label (23). The release film (22) protects the side where the protective film of the central control panel (21) and screen body (31) are pasted. After the release film (22) is separated from the protective film of the central control panel (21) by the tear-off label (23), the film can be affixed.

As a specific technical solution of this disclosure, a side of the automobile central control panel module (3) is provided with a screen body (31), and the other side (3) is provided with a central control panel bracket (32). The film scraping groove (14) is arranged inside the locator (11), and the central control panel bracket (32) is used for mounting the automobile central control panel module (33), which makes it convenient for users to operate. After the protective film of the central control panel (21) is pasted with the screen body (31), with a gently scratched or scraped middle part of the film scraping groove (14), the protective film of the central control panel (21) is self-exhausted and fits. At the same time, the arrangement of the film scraping groove (14) also reduces the self-weight of the locator (11) and saves processing materials.

As a specific technical solution of this disclosure, the distance between the two protrusions (25) is greater than the length of the protective film of the central control panel (21), and the distance between protrusion two (28) is greater than the width of the protective film of the central control panel (21). The opening of protrusion one (25) and protrusion two (28) facilitates the connection between the protective positioning film (24) and the locator (11) and facilitates the separation between the protective positioning film (24) and the protective film of the central control panel (21).

As a specific technical solution of this disclosure, the locator (11) is provided with an indicator sign (18) on the side facing away from the protective positioning film (24), and the indicator sign (18) is used to indicate the direction of film scraping. Both ends of the locator (11) are arranged in a curved shape. The length of the locator (11) is greater than the length of the protective film of the central control panel (21). After film sticking, the direction of the locator (11) is recognized by the indicator sign (18), and the protective positioning film (24) is protected by sliding the finger so that the protective film of the central control panel (21) is attached to the automobile central control panel module of the automobile (3), and both ends of the locator (11) are of curved design, while ensuring the integrity and appearance of the device, making it easier to use.

As a specific technical solution of this disclosure, triangular supporting protrusion one (21) is set on the side of the central control panel positioning stiffener (12), away from the protective film positioning column the (13), which ensures the structural strength of the central control panel positioning stiffener (12) and its stability.

As a specific technical solution of this present disclosure, the side of the locator (11) is provided with a double-sided adhesive groove on the side of the positioning column of the protective film (13) for pasting the 3M double-sided adhesive to improve the stability of the protective positioning film (24).

This disclosure relates to a film sticking method concerning a locator for film sticking on a central control computer screen of an intelligent automobile, wherein:

S1, while processing the film component (2) and manufacturing the protective film of the central control panel (21), pasting the protective positioning film (24) is on the side, and respectively arranging the positioning hole one (26), the positioning hole two (27) and the positioning hole three (29) on the protrusion one (25) and the protrusion two (28);

S2, assembling the film component (2), connecting the positioning hole one (26), the positioning hole two (27), and the positioning hole three (29) on the protrusion one (25) and the protrusion two (28) with the positioning film positioning column one (15), the positioning film positioning column two (16) and positioning film positioning column three (17), respectively; limiting the corners of the protective film of the central control panel (21) through the positioning column of the protective film (13) to keep the protective film of the central control panel (21) in a flat state;

S3, upon film sticking and tearing off the release film (22), aligning the central control panel positioning stiffeners (12) on the automobile central control panel module (3) and directly covering the automobile central control panel module (3) to clamp the central control panel positioning stiffeners (12) with the corner of the automobile central control panel module (3), lightly swiping in the middle of the film scraping groove (14), then the protective film of the central control panel (21) self-exhausting and fitting, breaking off of the locator (11), and separating the protective positioning film (24) from the protective film of the central control panel (21).

As a specific technical solution of this disclosure, after the protective film of the central control panel (21) in the S3 and screen body (31) are self-exhausted and fit, it takes at least 10 seconds before the locator (11) can be broken off, and the released film (22) is then torn and pasted back on the protective positioning film (24) to keep out dust.

While manufacturing the protective film of the central control panel (21), pasting the protective positioning film (24) on the side, and respectively arranging positioning hole one (26), positioning hole two (27), and positioning hole three (29) on protrusion one (25) and protrusion two (28). Connect positioning hole one (26), positioning hole two (27), and positioning hole three (29) on protrusion one (25) and protrusion two (28) to the positioning film positioning column one (15), the positioning film positioning column two (16), and positioning film positioning column three (17), respectively; limiting the corner of the protective film of the central control panel (21) through the protective film positioning column (13) to keep the protective film of the central control panel (21) in a flat state. Upon film sticking, and after tearing off the release film (22), aligning the central control panel positioning stiffener (12) on the automobile central control panel module (3), and directly covering the automobile central control panel module (3) to clamp the central control panel positioning stiffener (12) with the corner of the automobile central control panel module (3), and lightly swiping in the middle of the film scraping groove (14); then the protective film of the central control panel (21) self-exhausting and fitting, breaking off of the locator (11) after at least 10s, and separating the protective positioning film (24) from the protective film of the central control panel (21). The operation of the device is thus completed.

To sum up, for a locator for film sticking on a central control computer screen of an intelligent automobile and the film sticking method thereof, the protective film of the central control panel (21) is limited by the setting of the film sticking mechanism (1), the film component (2), and the cooperation of the locator (11) with the protective positioning film (24), so that the protective film of the central control panel (21) is kept in a flat state, which is conducive to the subsequent filming work. The operation is convenient and fast, the positioning is accurate, the structure is simple and the thickness is small. Consequently, manufacturing materials are saved, processing cost is reduced, economic benefits are conferred, and the application prospect is broad. The released film (22) can be affixed back onto the protective positioning film (24) after being torn off, so as to prevent dust and facilitate next use.

It should be mentioned that the terms “comprise”, “include”, or other variations are intended to cover non-exclusive inclusion, so that a process, method, article, or device covering a series of elements not only includes those elements, but also other elements not explicitly listed, or elements inherent in such a process, method, article or device. Therefore, in a case without more restrictions, the elements limited by the statement “comprise a . . . ” do not exclude the existence of other identical elements in the process, method, article, or device.

Although the embodiment of the present disclosure has been shown and described, ordinary technicians in this field can make a variety of changes, modifications, replacements, and variants under the principle and spirit of this present disclosure, and the range of the present disclosure is limited by the attached Claims and its equivalents.

What is claimed is:

1. A locator for film sticking on an intelligent automobile central control computer screen, comprising: a film sticking mechanism, a film component, and an automobile central control panel module, wherein: the film sticking mechanism is comprised of a locator arranged on a side with at least two central control panel positioning stiffeners, and the two control panel positioning stiffeners are diagonally arranged to clamp the automobile central control panel module; the central control panel positioning stiffeners are L-shaped; a side of the locator is provided with a positioning column of a protective film located inside the central control panel positioning stiffeners for positioning the film component; the side of the locator is provided with a positioning film positioning column one and a positioning film positioning column two on a side of the positioning film positioning column one;
the film component is comprised of a protective film of the central control panel with a protective positioning film arranged on a side; a side of the protective positioning film, which is far away from the protective film of the central control panel, is attached to the side of the locator, and both ends of the protective positioning film are provided with a protrusion one; an inner part of the protrusion one is provided with a positioning hole one, the inner part of the protrusion one is connected internally with the surface of the positioning film positioning column one and a positioning hole two, and the inner part of the protrusion one is connected internally with a surface of the positioning film positioning column two, and at least a positioning film positioning column three is provided at a top and a bottom of the side of the locator; a top and a bottom of the protective positioning film are provided with a protrusion two; an inside of the protrusion two is provided with a positioning hole three, which is connected internally to a surface of the positioning film positioning column three to limit the protective positioning film; a protective film positioning column protrudes and fits at a corner of the protective film of the central control panel to limit the protective film of the central control panel; an inverted part is provided at an end of the positioning film positioning column one, the positioning film positioning column two, and the positioning film positioning column three away from the locator.

2. The locator for film sticking on the intelligent automobile central control computer screen according to claim 1, wherein: a side of the central control panel protective film far away from the protective positioning film is provided with a release film and the release film far away from the protective film of the central control panel is also provided with a peel-off film label.

3. The locator for film sticking on the intelligent automobile central control computer screen according to claim 1, wherein: the automobile central control panel module is provided with a screen body on a side and the central control panel bracket on an other side of the automobile central control panel module; and a film scraping groove is arranged inside the locator.

4. The locator for film sticking on the intelligent automobile central control computer screen according to claim 1, wherein: a distance between the two protrusions one is greater than a length of the protective film of the central control panel, and the distance between the two protrusions two is greater than a width of the protective film of the central control panel.

5. The locator for film sticking on the intelligent automobile central control computer screen according to claim 1, wherein: an indicator sign one is provided on a side of the locator away from the protective positioning film, which is used to indicate a direction of a scraping film; and both ends of the locator are curved and a length of the locator is longer than the length of the protective film of the central control panel.

6. The locator for film sticking on the intelligent automobile central control computer screen according to claim 1, wherein: a triangular supporting protrusion is set on a side of the central control panel positioning stiffener away from the positioning column of the protective film.

7. The locator for film sticking on the intelligent automobile central control computer screen according to claim 1, wherein: the side of the locator is provided with a double-sided adhesive groove on a side of the positioning column of the protective film for pasting 3M double-sided adhesive.

8. A sticking method for the locator for film sticking on the intelligent automobile central control computer screen according to claim 1, comprising following steps:
S1, while processing the film component and manufacturing the protective film of the central control panel, pasting the protective positioning film on the side, and respectively arranging the positioning hole one, the positioning hole two, and the positioning hole three on the protrusion one and the protrusion two;
S2, assembling film component, connecting the positioning hole one, the positioning hole two, and the positioning hole three on the protrusion one and the protrusion two with the positioning film positioning column one, the positioning film positioning column two, and the positioning film positioning column three, respectively, and limiting corners of the protective film of the central control panel through the positioning column of protective film to keep the protective film of the central control panel in a flat state; and
S3, upon film sticking, after peeling off the release film, aligning the central control panel positioning stiffener on the automobile central control panel and directly covering the automobile central control panel to clamp the central control panel positioning stiffener with a corner of the automobile central control panel module, lightly swiping in the middle of the film scraping groove one and then the protective film of the central control panel self-exhausting and fitting, breaking off the locator, and separating the protective positioning film from the protective film of the central control panel.

9. The locator for film sticking on the intelligent automobile central control computer screen and the film sticking method thereof according to claim 1, wherein: after the protective film of the central control panel in the S3 and the screen body are self-exhausted and fit, it takes at least 10 seconds before the locator can be broken off, and the release film is then torn off and pasted back on the protective positioning film to keep out dust.
